(19) United States
(12) Patent Application Publication
(10) Pub. No.: US 2013/0332183 A1
(43) Pub. Date: Dec. 12, 2013

(54) Array of Drugs and Wellness Products

(71) Applicant: The Procter & Gamble Company, Cincinnati, OH (US)

(72) Inventors: Kyle Edward Garner, Keene, NH (US); Kyle William Harris, Maineville, OH (US); Alexis Marie Schrimpf, Cincinnati, OH (US)

(21) Appl. No.: 13/914,657

(22) Filed: Jun. 11, 2013

Related U.S. Application Data
(60) Provisional application No. 61/657,922, filed on Jun. 11, 2012.

(51) Int. Cl. G06Q 30/06; G06Q 50/22

(52) U.S. Cl. CPC G06Q 30/0623; G06Q 50/22
USPC 705/2

(57) ABSTRACT

An array of drug and wellness products. The array has a first category and a second category. Each category has at least two products and each product provides a drug benefit. The products are grouped in the array by category and drug benefit. The array can also comprise both wellness and treatment products.

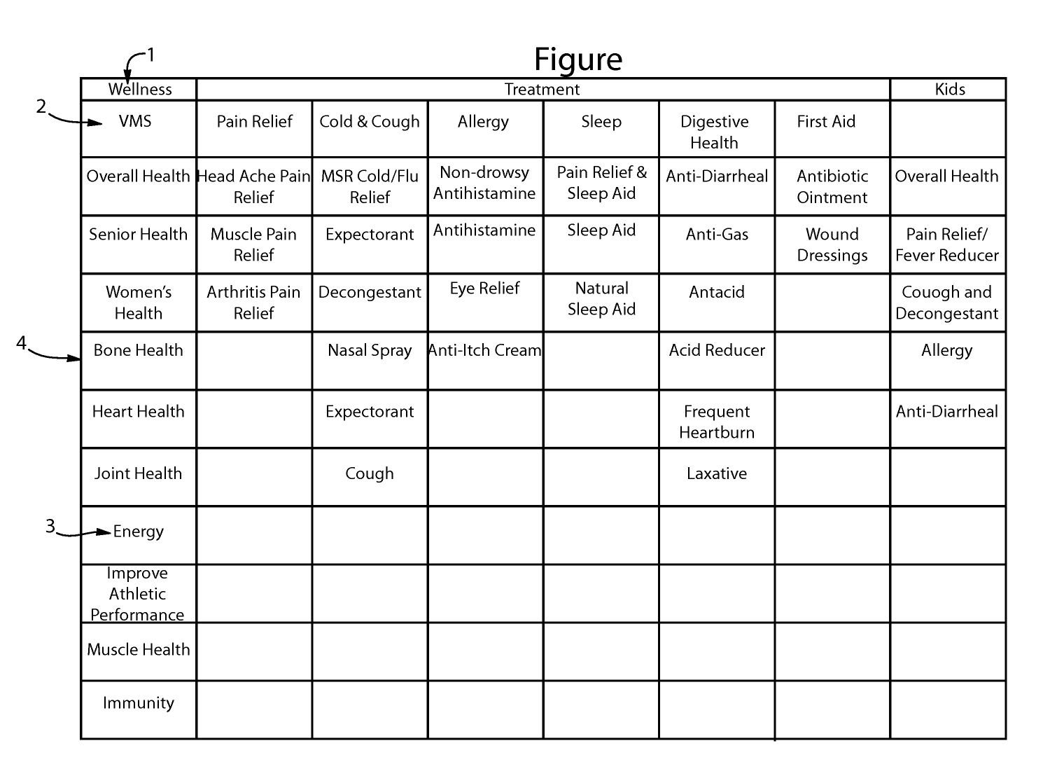

### CROSS REFERENCE TO RELATED APPLICATIONS

This application claims the benefit of U.S. Provisional Application No. 61/657,922, filed Jun. 11, 2012.

### FIELD OF THE INVENTION

The present invention is generally directed to an array of drug and wellness products.

### BACKGROUND OF THE INVENTION

Consumers are frequently confused when shopping for drug and wellness products. These products are difficult to find because pharmacies have become like old-fashion general stores, selling a wide variety of products including drugs, personal care products, wellness products, beauty products, household products, toys, and even food. Finding a drug or wellness product can also be difficult because the products can be located in different areas of the store.

For instance, when a consumer goes to the store to purchase a drug or wellness product they first have to find the area of the store where the product is located and there are often several aisles of drug and wellness products.

After the consumer finds the aisle and the section of the aisle with the type of product they are looking for, there are often several different products that appear to provide the same benefit. For example, a consumer looking for an over-the-counter allergy medication might be presented with a plethora of choices including Alka-Seltzer Plus® Allergy Formula, Allegra® Allergy Tablets 24 Hour, Alavert® Non-Drowsy Allergy Relief Orally Disintegrating Tablets, Benadryl® Allergy Ultratab Tablets, Benadryl® Severe Allergy Plus Sinus Headache, Claritin® 24 Hour Allergy Relief Tablets, Claritin-D® 24 Hour Allergy & Congestion Relief Extended Release Tablets, Claritin® 24 Hour Allergy Relief RediTabs Orally Disintegrating Tablets, Claritin® 24 hour Allergy Relief Liqui-Gels, Tylenol® Allergy Multi-Symptom rapid release gels, Tylenol® Severe Allergy, Zyrtec® Allergy Tablets, as well as store brands.

Consumers find that going to the store to purchase drug and wellness product is time consuming and confusing.

First, selecting the correct product is confusing because consumers often have a difficult time telling the difference between each product. Furthermore, it is common for a consumer to select the wrong product. For instance, they might select a nighttime product instead of a daytime product or a multi-active product when they really only wanted relief from a single symptom.

Additionally, products related to the same condition are generally shelved in non-adjacent locations in the store. For example cold products are distant from immunity boosting products and the consumer must go to several aisles and to get all of the products they need.

Furthermore, since there are so many products on the shelf, it is difficult for retailers to properly shelve the items. When products are shelved improperly it is even more difficult for a consumer to find the product and it is difficult to find the price.

There is a need to shelve drug and wellness products together to make shopping faster, easier and less confusing.

### SUMMARY OF THE INVENTION

An array of drug and wellness products comprising: a first category comprising a first product with a first benefit and a second product with a second benefit wherein the products are grouped according to benefit within the first category; and a second category comprising a first product with a first benefit and a second product with a second benefit wherein the products are grouped according to benefit within the second category.

An array of drug and wellness products comprising: a wellness super-category comprising a VMS (Vitamins, Minerals, and Supplements) category wherein the VMS category comprises a first VMS product with a first benefit and a second VMS product with a second benefit wherein the products are grouped according to benefit within the VMS category; and a treatment super-category comprising a first category wherein the first category comprises a first product with a first benefit and a second product with a second benefit wherein the products are grouped according to benefit within the first category.

### BRIEF DESCRIPTION OF THE DRAWING

While the specification concludes with claims particularly pointing out and distinctly claiming the subject matter of the present invention, it is believed that the invention can be more readily understood from the following description taken in connection with the accompanying drawing, in which:

The FIGURE is a schematic of the array of products.

### DETAILED DESCRIPTION OF THE INVENTION

Consumers frequently complain that they are confused and that products are not easy to find because there are too many products on the shelf and the products are located all over the store.

The array of the present invention comprises enough of the frequently-used products that the majority of consumers do not need to go to other areas in the store to purchase drug and wellness products. However, the choices are limited, which helps decrease confusion and makes the products easier to find. In addition, the products are organized by benefit and category. Furthermore, colors, patterns, and indicators that are directly on the shelf make the products easier to shelve and ultimately easier to find. Ultimately, the consumer is able to more easily find the product that provides the benefit they desire faster than with traditional pharmacy shelving methods.

As used herein, “ameliorate” means to make or become better.

As used herein, “brand” means that the product is sold to the retailer by a company or manufacturer and the brand distinguishes the products as produced or sold by that company or manufacturer.

As used herein, “drug products” refers to products sold directly to consumers to treat/prevent symptoms or sickness. Drug products provide a benefit to the consumer, and usually the benefit is alleviating a symptom. In one example, these products are Over the Counter (OTC) drugs. They can be products registered with regulatory agencies using monographs or drug applications.

As used herein, “end cap” means a display area for merchandise in store that is the hub at the end of an aisle.

As used herein, “indicia” means identifying marks or indications that provide information to the consumer. Non-limiting examples of indicia can include branding, words, phrases, letters, characters, brand names, company names, company logos or symbols, logos, icons, designs, designer names, insignias, shapes, alpha-numeric symbols, pictures, drawings, illustrations, photographs, computer-produced images, colors, sounds, textures, shapes, letters, numbers, and combinations thereof.

As used herein, “mitigate” means to alleviate or relieve symptoms.

As used herein, “prevent” or “preventing” means to keep from occurring.

As used herein, “price point” means the price at which a product is sold.

As used herein, “primary container” refers to the package that contains the unit doses. The primary container can be of varying shape and size as desired based upon the number, size and type of unit doses contained therein. In one example, the primary container can be sized to be conveniently portable. Non-limiting examples of primary containers can include box, bottle, blister card, stick pack, sachet or pouch, tube, and combinations thereof. A primary container can contain any number of unit doses. In one example, the primary container contains one unit dose. In one example, the primary container comprises unit doses that are intended to be consumed from 2 to 8 hours, in another example 4 to 8 hours, in another example 8 to 16 hours, in another example from 12 to 24 hours, in another example from 2 to 14 days, in another example from 3 to 12 days, in another example 4 to 10 days, in another example 5 to 9 days, in another example 6 to 8 days, and in another example 7 days. How the doses are intended to be consumed can be determined by package directions or guidance from the manufacturer, government health regulatory body or United States Federal Drug Administration (FDA). The directions can be printed on the primary container, printed on the secondary container, or can otherwise accompany the primary container, such as a package insert. In another example the primary container contains from 1 to 100 unit doses, in another example from 2 to 75 unit doses, in another example from 3 to 60 unit doses, in another example from 4 to 48 unit doses, in another example from 5 to 40 unit doses, in another example from 7 to 36 unit doses, in another example from 10 to 32 unit doses, and in another example from 16 to 24 unit doses. In one example the primary container comprises from 1 to 24 unit doses, in another example from 2 to 16 unit doses, in another example from 3 to 12 unit doses, and in another example from 4 to 10 unit doses. In another example, the unit dose is a liquid and the primary package comprises from 1 fluid ounce (fl. oz.) to 24 fl. oz., in another example from 1.5 fl. oz to 18 fl. oz., in another example 2 fl. oz. to 16 fl. oz., in another example 3 fl. oz. to 12 fl. oz., in another example 4 fl. oz. to 10 fl. oz., and in another example 6 fl. oz. to 8 fl. oz. In one example, all of the primary containers are full-size.

As used herein, “secondary container” means a package that contains the primary container or has an integrated structure with the primary container. The secondary container can be of varying shape, size and form as desired based upon the number, size and type of primary containers contained therein and/or formed as a part thereof, and can be sized to be conveniently portable. Non-limiting examples of such shapes and forms include round, oval, rectangular, square, triangular, trapezoidal, octagonal, foldable and combinations thereof. Non-limiting examples of secondary containers include boxes, cartons, and molded clam shell packaging. Non-limiting examples of integrated primary and secondary containers include tri-fold structures in which a primary container is affixed to a secondary container that folds over one or more portions of the primary container; and structures shaped and structured similarly to a book in which one or more primary structures form page-like structures bound within a secondary container outer covering forming an integrated structure. The primary and secondary containers can also be separate, discrete elements, and one or more primary containers can be removed from the secondary container, for example to be carried and used throughout the course of a day or the entire treatment. The secondary container can be made from a variety of materials, non-limiting examples of which include paper, paperboard, cardboard, plastic, and combinations thereof. In one example, there is no secondary container.

As used herein, “self checkout” means a mechanism for consumers to pay for purchases from a retailer without direct input to the process by the retailer's staff.

As used herein, “senior” means an adult who is older. In one example, a senior is over 50 years old, in another example over 55 years old, in another example over 60 years old, in another example over 65 years old, and in another example over 70 years old. In one example, senior can mean a woman who is post menopause.

As used herein, “Smartphone” means a mobile phone built on a mobile computing platform, with more advanced computing ability and connectivity than a feature phone. In one example, the Smartphone can have a digital camera. In another example, the Smartphone can have voice recognition software.

As used herein, “treat” or “treating” means preventing, alleviating, ameliorating, inhibiting, or mitigating one or more drug conditions in a mammal. In one embodiment, the mammal treated may be a human.

As used herein, “unit dose” or “unit dosage” means a dosage form containing an amount of an active or nutrient suitable for administration in one single dose, according to sound medical practice. In one example, the unit dose can include more than one dosage forms, for instance two tablets or capsules can comprise one unit dose. The dosage form may include a variety of product forms. Non-limiting examples of the most common dose forms include, but are not limited to compressed tablets, caplets, softgel capsules, solid-filled capsules, liquid-filled capsules, enteric-coated forms, sustained-release forms, solid lozenges, liquid-filled lozenges, mouth and throat drops, effervescent tablets, orally disintegrating tablets and combinations thereof. Dosage forms are typically swallowed immediately, slowly dissolved in the mouth, or chewed. In another example, the unit dose may be applied topically to the skin such as a wound dressing, adhesive bandage, sticking plaster or transdermal patch.

As used herein, “wellness product” refers to products designed to contribute to a consumer's health while not specifically treating or preventing a condition or disease. Examples include products sold as dietary supplements. In one example, wellness products include those regulated under the United States Dietary Supplement Health and Education Act (DSHEA). Additional examples include vitamins, minerals, botanicals, oils, natural products, and fiber that do not claim to treat/prevent a disease.

FIGURE shows a schematic view of the array. In this example, the array is a vertical array. The array can be arranged by super-category 1, category 2, and benefit 3. The products are arranged by benefit 3. The array fits within a store shelf 4.

In a non-limiting example, a consumer goes to a store because she has a cold and needs one or more products to help alleviate her symptoms. First, the consumer locates the array in the store. In one example, the array can be located in an end cap near the pharmacy. Then, the consumer will look at the array to find the cough cold category. The cough cold category can be recognized because there can be a sign at the top of the category that says “cough cold” and all of the products in the category can be the same color. The cough cold category can include products for treating the symptoms of a cold. Once identifying the cough cold category the consumer can look at the products to find the one she needs. Each product can have the benefit written clearly on the package, for instance products in the cold cough category can have “cough relief” or “relieves nasal congestion” printed on the secondary package. Once the consumer finds the product with the benefit she needs she can purchase the product. In one example, each benefit only has one product which simplifies selecting the correct product. Also, there can be one or two products per benefit which can also simplify the selection process.

Currently, consumers have difficulty determining which product they need to provide the benefit they want and finding the product in the store. The way the packages are set up in the array makes it easier for consumers to find and select the products they desire. In one example, the products can be positioned on the shelf in such a way that if the consumer finds the product that they came into the store looking for, the array will direct them to other related products that may also be useful. For instance, in one example a multi-symptom relief cold flu product is near or adjacent to a vitamin, mineral, and supplement (VMS) product that helps support immunity. Related products that are in different categories can be located in the same row, column, or in an adjacent grouping to help consumers choose products that will give them the best possible benefits. In another example, the cough and cold category and the pain relief category can be adjacent or near one another, because consumers with nasal congestion or other cold symptoms may also want pain relievers for symptoms such as a headache or fever.

In another example, there is a guidance feature that can help the consumer select the correct product or help the consumer find the correct product. In one example, this guidance feature is a Smartphone application with a series of questions to determine what product is best for the consumer. For instance, some consumers have trouble determining whether they have a cold or an allergy and this application would help and then help recommend products that would provide a benefit. In another example, this process might be done using a natural language user interface that is accessed at the store shelf, by calling a phone number to get assistance, scanning something with a Smartphone that will direct you to a website to answer these questions, or using a radio-frequency ID tag.

In another example, the guidance feature helps the consumer find the product on the shelf. In one example, the guidance feature is a Smartphone application that helps the consumer to find the product on the store shelf. In one example, the consumer could tell, either by typing or talking to the Smartphone, what she is looking for and the Smartphone could direct the consumer to the product on the shelf. This application could either use the camera technology or recognize the product. In another example, the array in each store is set up the same and the Smartphone can direct the user to the product in the array.

The colors on the shelf and the secondary packaging can also provide further guidance and enable the consumer to quickly and accurately decide what products they need.

The array can also make subsequent shopping trips easier. In one example, the array is set up the same or substantially the same in all retailers, which can mean that the array has the same products and the products are shelved in the same configuration. Furthermore, the category color is the same, so whether the consumer is at the same location or a different location, finding the desired product is faster with subsequent trips because the consumer already knows what the category is called and what the category color is.

The array can be any size. In one example, all of the products in the array are within arm's reach. In another example, the array in displayed within a merchandising display area that is from 0.5 meters (m) to 6 m wide, in another example 1m to 4 m wide, in another example 1.25 m to 3 m, and in another example 1.5 m to 2.5 m. In another example, the array is displayed within a merchandising display area that is from 0.5 m to 4 m tall, in another example 1m to 3 m tall, in another example 1.5 m to 2.75 m, and in another example 2m to 2.5 m. In another example the array is from 0.25 m to 2 m deep, in another example 0.5 m to 1.5 m, and in another example 0.75 m to 1.25 m deep. In yet another example, the array is displayed within a merchandising display area that is 1.5 m wide, about 2 m tall and 1 m deep.

The array can be located anywhere. In one example, it is located inside the store near the pharmacy, in another example it is located inside the store near the checkout, in another example the array is movable and can change locations either inside the store or outside the store. In one example, the array is located at the end of the aisle in an end cap. The array can take up the entire end cap or it can take up a portion of the end cap. In another example, the array is located in an aisle; it can be at an end of the aisle or in the middle of an aisle. In one example, the array can be a free-standing kiosk that can be located in an open area so consumers can reach it from multiple directions. In another example, the array is able to easily be moved to different areas of the store. For instance, during cold and flu season the array might be located with the winter items such as winter clothing, winter sports equipment such as ice skates and sleds, or winter tools such as shovels, ice scrapers, and salt and during the spring season the array might be located with the spring items such as tools for gardening, plants, and spring apparel.

In one example, the array is inside a vending machine which can be placed inside or outside a store, office building, gas station, or a public transportation terminal such as a bus stop, train station or airport. In one example, a consumer can use the vending machine to select the one or more products that she wants to buy and she can pay at the vending machine using any payment method such as cash, credit card, prepaid gift card, or using their Smartphone. In one example, there is an application on a Smartphone that can allow the consumer to quickly pay or select the products. In another example, the consumer can input their symptoms and the vending machine can recommend products. In another example, the consumer can input the number of doses they want and the machine will dispense the correct number of doses.

In one example, the array can be located inside a store and the customer can use a self checkout attached to or located near the array, to enable her to purchase the product more efficiently. In another example, the self checkout can be located within 20 feet of the array, in another example within 15 feet, in another example within 12 feet, in another example within 8, in another example within 5 feet, and in another example within 3 feet. In one example, the self checkout can be intended only for checking out items purchased from the array, in another example the self checkout can be used with items purchased in the pharmacy area of the store, and in another example the self checkout can be used for items purchased anywhere in the store.

In one example, the array is a virtual array. The virtual array can be a simulation of the actual array. The virtual array can be the same size as the actual array, smaller than the actual array, or larger than the actual array. Consumers can use their Smartphone to scan the products they want to buy and the consumer can then pick up the scanned products later at another location or the scanned products may be delivered to the consumer. In one example, the virtual array can be in a public area such as a public transportation terminal. In another example, the virtual array can appear on a television, computer, phone, or tablet screen and the consumer can select the products that she wants and then pick them up or have them delivered.

The array comprises drug and wellness products. If the array comprises too many drug and wellness products, consumers become overwhelmed and it takes the consumer longer to find the product that they might need and the consumer may accidentally select and purchase the wrong product. If there are too few products in the array then many consumers will not be able to find what they need and may have to go to another portion of the store. In one example, the array can comprise from 10 to 100 products, in another example 20 to 80 products, in another example 30 to 70 products, in another example 32 to 60 products, in another example 35 to 50 products, and in another example 40 to 46 products. In one example the array can have more than 10 products, in another example more than 15 products, in another example more than 20 products, in another example more than 25 products, in another example more than 30 products, in another example more than 35 products, in another example more than 40 products, in another example more than 45 products, and in another example more than 50 products.

The array can include the most commonly purchased products in the drug and wellness categories. In one example, the array can comprise greater than 90% of the most commonly purchased drug and wellness products, in another example greater than 85%, in another example greater than 80%, in another example greater than 75%, in another example greater than 70%, in another example greater than 65%, in another example greater than 60%, in another example greater than 55%, in another example greater than 50%, and in another example greater than 45%.

The array can be separated into categories. Too many categories can make it difficult for the consumer to find the products they need. If there are two few categories then there may not be enough products to cover a broad range of drug and wellness needs or each category can have too many products which would make it difficult to find the correct product as well.

In one example, the array can comprise 2 to 20 categories, in another example 3 to 18 categories, in another example 4 to 15 categories, in another example 5 to 12 categories, in another category 6 to 10 categories, and in another category 7 to 9 categories. In one example, the array comprises 7 categories and in another example the array comprises 9 categories.

In one example, each category comprises 2 to 15 products, in another example 3 to 12 products, in another example 4 to 10 products, in another example 5 to 9 products, and in another example 6 to 8 products. The number of products in each category can be equal but it does not have to be equal.

In one example, the products are arranged so 50% or more of the products only have one front, in another example 70% or more of the products only have one front, in another example 80% or more of the products only have one front, in another example 90% or more of the products only have one front, and in another example 100% of the products only have one front. Only having one front means that when the array of products is viewed from the front, the product can only be seen once.

Each category can provide a plurality of benefits and each benefit can be provided by one or more products. In one example, each benefit is provided by one or two products, and in another example each benefit is provided by only one product.

In one example, each product is available in only one size, in another example each product is available in one or two sizes, and in another example the product is available in between one and three sizes.

In one example, all of the products in the array are from the same brand. In another example, each category has its own brand. In another example, the treatment, wellness and children's super-categories can each have a different brand. In another example, the treatment, wellness, and children's super-categories can all have the same brand. While not wishing to be bound by theory, consumers may prefer to have all of the products come from the same brand because this allows them to know the manufacturer or company who sells the products and identify a brand in which they have developed a perceived trust for providing safe and effective products. Furthermore, having one brand or a limited number of brands can help simplify the shopping experience.

The categories are arranged in the array in a way to help consumers find and select the product they want. In one example the categories are vertically arranged in columns and extend from the top of the array to the bottom of the array; in another example the categories are arranged horizontally in rows and extend from one side to another; in one example all of the categories are the same size; in another example the categories are different widths but the same height; in another example the categories are different heights but the same width; in another example the categories are vertically arranged in columns but do not extend the entire height of the array; in another example the categories are horizontally arranged in rows but do not extend the entire width of the array; in another example the categories are vertically arranged in columns and at least one category is horizontally arranged in a row; in another example the categories are horizontally arranged in rows and at least one category is vertically arranged as a column; in another example the categories are not the same size; and in another example the categories are arranged in groups, which can be any size and can extend vertically or horizontally. In one example, there will be at least two vertical groupings and at least two horizontal groups and in another example there will be at least three vertical groupings and at least three horizontal groupings.

Non-limiting examples of categories can include VMS, pain relief, cough and cold, allergy, sleep, digestive drug, eye health, ear health, skin conditions, contraception and sexual health, first aid, tests and kits, smoking cessation, stimulants, children's, women's, men's, young adults, preadolescences, adults, senior men, senior women, adults, menopausal women, post-menopausal women, weight loss, medical condition, and combinations thereof. Non-limiting examples of drug conditions can include diabetes, heart disease, cancer, osteoporosis, depression, asthma, arthritis, cold and flu, Alzheimer's disease and memory loss, autoimmune diseases, high blood pressure, high cholesterol, headaches and migraines, obesity, premenstrual syndrome, and combinations thereof.

In one example, the categories do not include home care products, for example home cleaning, dish soap, all purpose cleaners, tub and tile cleaners, floor cleaners, wood cleaners and the like. In another example, the products do not comprise personal care products, for example hand soap, hand lotion, shower gel, shampoo, conditioner, shaving products, bath brushes, sponges, loofas and the like. And in another example, the categories do not include laundry care products, for example laundry detergent, fabric softener, dryer sheets, laundry soap and the like products.

In one example, the array is arranged so the products, in particular the VMS products, do not overlap with one another. For instance, consumers are often frustrated and confused when selecting VMS products because they want a wide range of benefits but do not want to double up on certain vitamins, because too much of certain vitamins can be problematic or wasteful. The array can provide consumers with confidence that they will not double up on vitamins. In one example, any product in the adult super-category or the VMS category can be taken with any other product in the adult-super category or the VMS category and the consumer does not have to worry about excessive consumption. In another example, any product in the children's super-category can be consumed with any other product in the children's super-category and the adult consumer and child does not have to worry about excessive consumption.

In one example, the array comprises both the adult super-category and the children's super-category and both super-categories provide more than 2 benefits, in another example more than 3 benefits, in another example more than 4 benefits, in another example more than 5 benefits, in another example more than 6 benefits, in another example more than 7 benefits, and in another example more than 8 benefits.

In one example, the categories are arranged into super-categories. Non-limiting examples of super-categories can include treatment, wellness, adult, child, and combinations thereof. Non-limiting examples of treatment products can include pain relief, cough and cold, allergy, sleep, digestive drug and non-limiting examples of wellness products can include VMS.

In one example, the categories are arranged vertically in columns and the wellness products are on one side, for instance the left when the array is viewed from the front, and the treatment products are on the other side, for instance the right when the array is viewed from the front. In one example, the children's category is located on one side of the array, for instance the right side when the array is viewed from the front, and the adult is located towards the left. One example has the VMS category on one side, the children's category on the other side, and the treatment super-category in the middle.

Non-limiting examples of benefits of using a product in the VMS category can include improving or maintaining overall drug and well-being, increasing energy, reducing stress, enhancing immune function, improving or maintaining bone drug, improving or maintaining eyesight, improving or maintaining brain function, improving or maintaining cardiovascular drug, preventing osteoporosis, improving or maintaining mobility and joint drug, improving sleep, reducing aging, improving digestion, and improving or maintaining the appearance and texture of skin, hair, and nails. Non-limiting examples of products in the VMS category can include a universal multi-vitamin, a senior multi-vitamin, a women's multi-vitamin, fish oil, glucosamine, vitamin B complex with vitamin C, vitamin C, vitamin D3, iron, magnesium, and combinations thereof.

Non-limiting example of benefits of using a product in the pain relief category can include headache relief, muscle ache relief, backache relief, post-surgical pain relief, sinus pain, relief of aches and pains related to a cold or flu, and combinations thereof. Non-limiting examples of products in the pain relief category can include acetaminophen, ibuprofen, aspirin, naproxen sodium, and combinations thereof.

Non-limiting benefits of using a product in the cold cough category can include treating or mitigating chest congestion, rhinorrhea, coughing, sneezing, headache, malaise, sore throat, difficulty breathing, sinus pressure, sinus pain, and combinations thereof. Non-limiting examples of products in the cough and cold category can include dextromethorphan, guaifenesin, phenylephrine HCl, pseudophedrine, oxymetazoline HCl, and combinations thereof.

Non-limiting benefits of using a product in the allergy category can include preventing, mitigating, or treating symptoms of an allergy attack such as red eyes, itchiness, runny nose, eczema, hives, an asthma attack, sinus congestion, and combinations thereof. Non-limiting examples of products in the allergy category can include fexofenadine HCl, diphenhydramine HCl, ketotifen, hydrocortisone, and combinations thereof.

Non-limiting benefits of using a product in the sleep category can include pain relief, and relief from insomnia, anxiety, sleeplessness, and difficulty falling asleep. Non-limiting examples of products in the sleep category can include diphenhydramine HCl, doxylamine, melatonin, and combinations thereof.

Non-limiting benefits of using a product in the digestive drug category can include restoring digestive balance, treating gastrointestinal symptoms, and combinations thereof. Non-limiting examples of gastrointestinal symptoms can include diarrhea, constipation, upset stomach, vomiting, sour stomach, cramps, gas, bloating, stomach ache, lactose intolerances, sore throat, difficulty swallowing, unintentional weight loss, visceral hypersensitivity, feeling of fullness, indigestion, nausea, heartburn, urgency to have a bowel movement, lack of appetite, regurgitation, belching, flatulence, blood in stool, dehydration, and combinations thereof. Non-limiting examples of products in the digestive drug category can include loperamide HCl, omeprazole, simethicone, calcium carbonate, ranitidine, delayed-release lansoprazole, polyethylene glycol, and combinations thereof.

Non-limiting examples of benefits of using a product in the first-aid category can include preventing, treating, or mitigating bacterial infections, promoting healing, preventing future harm, debriding a wound, removing debris from a wound, assisting in diagnosing an illness or disease, stabilizing a wound, treating or preventing blisters, and combinations thereof. The first-aid category can comprise products that are frequently found in a first aid kit. Non-limiting examples of products in the first aid category can include antibiotic ointment comprising bacitrican zinc, neomycin, polymyxin B sulfate, praxomine; adhesive bandages, rolled bandages, gauze, moleskin, elastic bandages, scissors, tweezers, and thermometer.

The children's category can provide any of the benefits recited above. However, instead of an adult receiving the benefit, a child receives the benefit. Non-limiting examples of products in the children's category can include ibuprofen, acetaminophen, a cough and decongestant comprising brompheniramine maleate, dextromethorphan, and pheneylephrine HCl; loperamide HCl, cetirizine, and a children's multivitamin. The dosage units in the children's category can be different than a similar product in the adult categories. Non-limiting examples of differences can include a different amount of active, a different shape or size, a different flavor, and combinations thereof.

The products can also be products that were originally only available with a prescription or behind pharmacy counter, but are now available over the counter.

Each product in the array is available at a price point, which is a particular price point such as $5.99. In one example, there are no more than 5 different price points for the entire array; in another example no more than 4 different price points; in another example no more than 3 different price points; in another example no more than 2 different price points; and in another example no more than 1 price point. A limited number of price points can help to simplify shopping because it makes it easier for the consumer to determine how much each item costs. In one example, the products can be arranged in the array by price point.

The primary container contains the unit doses of the product. In one example, each product in the array has the same number of unit doses; and in another example the number of unit doses varies by product.

The products can have both a primary container and a secondary container. In one example, the secondary container is a box. The array comprises a plurality of products in secondary containers. In one example, the secondary containers are all the same size and in another example the size of the secondary container varies. In one example, the indicia on the secondary container is such that the secondary container is in a vertical position on the shelf, in another example the indicia on the secondary container is such that the secondary container is in a horizontal position on the shelf.

In one example, the array can comprise a limited number of shapes of secondary containers. In one example, the array comprises no more than 10 different secondary container shapes, in another example no more than 8 shapes, in another example no more than 6 shapes, in another example no more than 4 shapes, in another example no more than 3 shapes, and in another example only 1 shape.

The secondary containers across the entire array can be coordinated. In one example, the secondary container has a category color, which means that each category has a different color, for instance the secondary containers in the VMS category can be purple, and the secondary containers in pain relief category can be yellow, and the secondary containers in the cough-cold category can be green. In another example, the secondary container can be a different color for each active. In another example, the secondary container can be a different color for each category and the secondary container for each product in a category can be a different shade within the same color.

In one example, the secondary containers across the entire array can be the same color. In another example, the secondary containers across the array can be at least 10% the same color and at least 80% the category color, in another example the secondary containers can be at least 20% the same color and at least 50% the category color, in another example the secondary container can be at least 30% the same color and 30% the category color.

In one example, the secondary containers can have different colors, however all of the secondary containers have the same pattern. In another example, the secondary containers can have different patterns that coordinate across the entire array, for instance the pattern on each box might combine together across the entire array to form a larger shape, image or pattern. This kind of patterning could make shelving easier by making errors more obvious.

In another example, the shelves can also have the category color. The category color can be below the product, above the product, behind the product or combinations thereof. In another example, the shelving can be modular comprising modules and the modules can be containers which hold the products. In one example, the modules can be colored to correspond with the category color. In one example, the modules can have indicia on the sides and the indicia can coordinate across the entire array. In another example, the module can be rectangular and in another example the module can be square. In one example, the modules can have different indicia on at least two sides and therefore the modules can be rotated and the shelves will appear to look different. In one example, the modules can be rotated based on the season.

The corresponding color on the shelves and the box can make proper shelving easier leading to more uniform shelving which makes it easier for consumers to quickly and accurately find the products they want.

In another example, the shelves have indicia that extend above the shelf. In one example, this directs the consumers to the super-categories, and in another example to the categories.

In another example, the shelf and the primary container or the secondary container can fit together like a lock and key. In another example, the shelf and the primary or secondary container can have shapes that fit together, such as, convex and concave surfaces or pins and tails as in a dovetail joint. In another example the primary and secondary containers fit openings or depressions in the shelving. These features can provide for higher accuracy in restocking and maintenance of the correct placement of the array of products.

The secondary packaging also provides indicia that clearly indicates to the consumer what the product is. In one example, the front or display portion of the packaging can have less than 100 words excluding the brand mark; in another example less than 75 words excluding the brand mark; in another example less than 50 words excluding the brand mark; and in another example less than 30 words excluding the brand mark, in another example less than 25 words excluding the brand mark, in another example less than 20 words excluding the brand mark, in another example less than 15 words excluding the brand mark, and in another example less than 10 words excluding the brand mark.

In another example, the product's benefit is clearly indicated on the front of the secondary package; in one example only one benefit is stated; in another example one or two benefits are stated; and in another example between one and three benefits are stated. In one example the benefit can be written on a single line with no other words. In another example, the written description of the benefit is at least 5 millimeter (mm) tall, in another example at least 7 mm tall, in another example at least 1 centimeter (cm) tall, in another example at least 1.5 cm tall, and in another example 2 cm tall. In another example, the benefit is an icon or photo that represents the benefit. For instance, a product in the sleep category might have a photo or icon of a person sleeping, stars, a feather, or a pillow and a product in the allergy category might have a picture of a person sneezing, a flower or ragweed.

In another example, the primary packaging has similar indicia to the secondary packaging. In one example, the top of the primary packaging is the category color, the top can refer to the top of a bottle or a top portion of a box. In another example, the back of a blister card is the category color. In another example, the benefit or product name is clearly printed on the top, allowing consumers to easily organize and locate the product once they purchase the product.

The products can also help consumers organize and locate the products at home. It is common for consumers to put over the counter medicines in a cabinet, closet, box, drawer, or shelf. Some of the drug and wellness products are used regularly, however, many products are used irregularly and consumers can find it difficult to determine which products they already own and what benefits those products provide. In one example, the primary packages can interlock to assist in keeping them organized. In another example, there can be a separate organizer that can fit a shelf or drawer or be used separately that can help organize the products. In one example, the at home organizer helps the consumer organize similarly to the way the products are arranged in the array at the store. In another example, the products can be organized in a way different from the array in the store. In another example, indicia can be located on a panel other than the front panel, such as a side panel, that helps organize the products. In another example, the organization can clearly shows when a product is missing, thereby acting as a reminder to purchase an additional product.

In one example, the products can be easier to organize because they are all the same size, in another example all of the secondary containers are approximately the same size.

In one example, a kit of products can be sold together. In one example 6 products can be sold together, in another example 8 products, in another example 10 products, in another example 12 products, in another example 14 products, in another example 16 products, and in another example 20 products. In one example, these products can be refilled as needed. In another example, the kit can be sold in a reusable organizer. In another example, all of the products in the kit can have an expiration date within six months of each other, which can make it easier to know when the products need to be replaced. In another example, all of the products can be bundled and sold together

In one example, the kit can include one or two products from each category and be sold as a starter kit. In one example, the starter kit can have the one or two most frequently sold items from each category. The starter kit can be used by anyone, in particular a college student, a person who is living on their own for their first time, or a person who just purchased a new home.

In another example, the kit can comprise only VMS products, which can be particularly helpful to the consumer because it assures the consumer that they are not doubling up on products and it can assure the consumer that they are getting a complete range of health benefits from the VMS products. In one example the kit has more than two VMS products, in another example more than three, in another example more than four, and another example more than five.

The kit can include products that are intended to be used by people with certain health conditions. In another example, the kits are marketed to seniors, young adults, diabetics, or other groups and contain products that are frequently used by people who fall within these groups. In one example, the kit is a kit that can be used by seniors and non-limiting examples of products that can be in this kit can include a product from the VMS category such as a product for joint health and/or a senior multi-vitamin, a product from the sleep aid category, a product from the digestive health category such as an antacid, products to promote eye health, products to promote ear health, products for skin conditions, and combinations thereof. In another example, the kit can comprise products that are diabetic friendly, such as products that are sugar free.

In another example, a kit can be a pain kit and non-limiting examples of products in the pain kit can include a muscle pain reliever, a sleep aid, a wound dressing, and a product from the VMS aisle for muscle health or immunity. In another example, the product can be sold as a cold kit and non-limiting examples of products in the cold kit can include a product from the VMS aisle for immunity, a product from the pain relief category for headache relief, as well as one or more products from the cough cold category, and combinations thereof. In another example, the kit can be an overindulgence kit and non-limiting examples of products in the overindulgence kit can include a product from the VMS category such as an immunity product, a pain reliever such as a product for head ache pain relief, a product from the sleep category, a product from the digestive health category such as an acid reducer, and combinations thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An array of drug and wellness products comprising:
a. a first category comprising a first product with a first benefit and a second product with a second benefit wherein the products are grouped according to benefit within the first category; and
b. a second category comprising a first product with a first benefit and a second product with a second benefit wherein the products are grouped according to benefit within the second category.

2. The array of claim 1 wherein the array further comprises a third category comprising a first product with a first benefit and a second product with a second benefit wherein the products are grouped according to benefit.

3. The array of claim 1 wherein the first category is VMS.

4. The array of claim 1 wherein the first category has a first color and the second category has a second color and the first color and the second color are different.

5. The array of claim 1 wherein the array comprises from 20 to 80 products.

6. The array of claim 1 wherein the array comprises from 35 to 50 products.

7. The array of claim 1 wherein all of the products in the array are within arm's reach.

8. The array of claim 1 wherein the array comprises greater than 70% of the most commonly purchased drug and wellness products.

9. The array of claim 1 wherein the categories are arranged vertically.

10. The array of claim 1 further comprising a guidance feature.

11. The array of claim 10 wherein the guidance feature is an application on a Smartphone.

12. An array of drug and wellness products comprising:
a. a wellness super-category comprising a VMS category wherein the VMS category comprises a first VMS product with a first benefit and a second VMS product with a second benefit wherein the products are grouped according to benefit within the VMS category; and
b. a treatment super-category comprising a first category wherein the first category comprises a first product with a first benefit and a second product with a second benefit wherein the products are grouped according to benefit within the first category.

13. The array of claim 12 wherein the treatment super-category further comprises a second category comprising a first product with a first benefit and a second product with a second benefit wherein the products are grouped according to benefit within the second category.

14. The array of claim 12 further comprising a children's super-category.

15. The array of claim 12 wherein the first category is selected from the group consisting of pain relief, cough and cold, allergy, sleep, digestive drug, first aid, children's, and combinations thereof.

16. The array of claim 12 wherein the array comprises from 20 to 80 products.

17. The array of claim 12 wherein all of the products in the array are within arm's reach.

18. The array of claim 12 wherein the array comprises greater than 70% of the most commonly purchased drug and wellness products.

19. The array of claim 12 further comprising a guidance feature.
